(19) United States
(12) Patent Application Publication
(10) Pub. No.: US 2011/0122401 A1
(43) Pub. Date: May 26, 2011

(54) Method and Apparatus For Verifying the Termination Quality of an Optical Fiber Interface in a Fiber Optic Cable Connector

(75) Inventors: Jack E. Caveney, North Palm Beach, FL (US); Gregory L. Kuffel, Plainfield, IL (US); Brett Lane, Hinsdale, IL (US)

(73) Assignee: Panduit Corp, Tinley Park, IL (US)

(21) Appl. No.: 12/992,441

(22) PCT Filed: May 28, 2009
(86) PCT No.: PCT/US09/45458

§ 371 Date: Jan. 25, 2011

Related U.S. Application Data
(60) Provisional application No. 61/057,067, filed on May 29, 2008.

(51) Int. Cl. G01N 21/00

(52) U.S. Cl. 356/73.1

(57) ABSTRACT

A method and apparatus for verifying the termination quality of an optical fiber interface in a fiber optic connector is provided. The test apparatus generally comprises a light source providing light to a test connector which contains an interface of a stub fiber of a fiber optic connector and a field fiber of a fiber optic cable. The portions of the test connector that are located between the optical fiber optic interface and the light detector are transmissive while other portions of the test connector located near the interface are highly reflective.

### FIELD OF THE INVENTION

The present invention relates generally to fiber optic connections and more specifically to a novel apparatus and method to measure the performance of a fiber optic connector.

### BACKGROUND OF THE INVENTION

Fiber optic networks are becoming increasingly commonplace in telecommunications applications. However, proper alignment between abutted glass cores within a fiber optic interface is crucial to the performance of the connections within fiber optic networks. Additionally, field installation of standard “pot and finish” fiber optic connectors is extremely labor and expertise intensive. In most applications, an installer is required to prepare a fiber end, glue the fiber end in the connector, cleave the excess fiber from the end face of the connector, and polish the end face of the connector to obtain the optimum geometry for optical performance. End face polishing is a difficult and time-consuming step, particularly when using single mode fiber, which achieves its best performance when using an automated polishing machine. However, automated polishing machines are often large and expensive, rendering them impractical for field use.

Fiber pigtail connectors eliminate the need for such lengthy steps and are factory prepared with a length of fiber. However, these require a fusion splicing machine and protective sleeve, which are expensive.

Fiber stub connectors were designed to eliminate the need for fusion splicing equipment and lengthy termination steps. The fiber stub connector employs a short fiber stub that is spliced to the field fiber within the connector. Stub connectors typically require a crimp to activate the splice or retain the field fiber, or both. However, the crimping operations, whether occurring at the interface point or some other point to retain the field fiber, have a tendency to pull the field fiber and stub fiber apart, or otherwise damage the signal passing function of the interface.

Moreover, if the connection is found to be poor after crimping, the connector must be cut off because crimping is most often an irreversible operation. This wastes a stub fiber connector and a length of fiber optic cable and requires a new connector and fiber optic cable end to be terminated.

Recently, reusable or re-terminable fiber stub connectors have been developed, such as that disclosed in commonly assigned U.S. Pat. No. 7,011,454, the subject matter of which is hereby incorporated herein by reference in its entirety. Another known reusable or re-terminable fiber stub connector is disclosed in commonly assigned U.S. Pat. No. 7,346,256, the subject matter of which is also hereby incorporated herein by reference in its entirety.

Because of the small size of such re-terminable connectors, it is often difficult to terminate such connectors in the field. In order to verify the adequacy of the termination of a fiber optic connector, such as the ones disclosed in the '454 and '256 patents, it is useful to detect light scattered at the interface of the optical fibers in the connector in order to verify that the amount of scattered light is within acceptable limits. The detection of light emitted from a connector in the region of an optical fiber interface can provide a way to approximate the insertion loss (or otherwise determine the quality) of the fiber optic connector. U.S. Pat. No. 4,360,268 discloses the use of an integrating sphere to directly measure the amount of scattered light. U.S. Pat. No. 7,192,195 discloses the use of one or more fiber optic strands to collect light and guide it to a measurement device. However, even measuring the scattered light at multiple locations still may not enable an accurate measurement of the total amount of scattered light because the light may not scatter evenly or in the direction of the light collecting points. Thus, it is unlikely that the total amount of scattered light will be measured by only a limited number of light collecting points.

As a result, it is desirable to provide a method and apparatus that will be able to detect the light emitted from an optical fiber interface that is not initially scattered in the direction of one of the light collecting points.

### BRIEF DESCRIPTION OF FIGURES

FIG. 1 is a system overview of an apparatus for verifying the termination quality of an optical fiber interface in a fiber optic connector.

FIG. 2 is a cross sectional view of a prior art test connector.

FIG. 3 is a cross sectional view of a test connector for use in the apparatus of claim 1.

FIG. 3a is a perspective view of a top plank of the test connector of FIG. 3.

FIG. 3b is a cross sectional view of the top plank of FIG. 3a taken along line 3b-3b of FIG. 3a.

FIG. 4 is a flow chart detailing a method for verifying the termination quality of an optical fiber interface in a fiber optic connector.

### DETAILED DESCRIPTION OF THE PREFERRED EMBODIMENTS

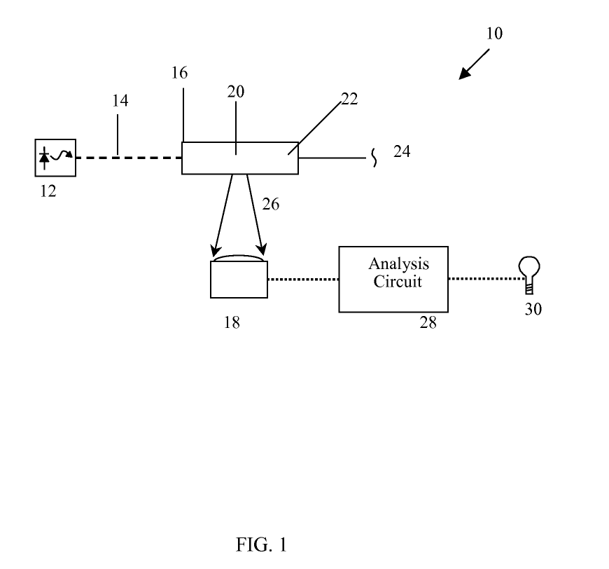

As shown by FIG. 1, one embodiment of an apparatus 10 to verify the termination quality of an optical fiber interface in a pre-polished fiber optic connector comprises a light source 12 supplying light to a test connector 22. The light source 12 may be comprised of a relatively narrowband emitter, such as a semiconductor LED or laser, or a relatively broadband emitter, such as a gas discharge arc lamp or filament lamp. The light is transferred from the light source 12 to the test connector 22 via a coupling assembly 14. In one embodiment, the coupling assembly 14 comprises a fiber optic cable connected to the light source 12 at one end and a test connector interface 16, which can comprise a fiber optic adapter, at the other end. In another embodiment, the coupling assembly 14 is composed of free space optical components such as lenses and apertures. The emission spectrum of the light source 12 is chosen such that light energy is efficiently transmitted by the coupling assembly 14 and optical fibers and also such that the light is efficiently detected by the light detector 18.

As the light from the light source 12 reaches the test connector 22, it will either be coupled to a field fiber 24 or be scattered into the test connector 22. Some of the light that is scattered into the test connector 22 will pass though transmissive portions of the test connector 22 to a light detector 18. In a preferred embodiment, the components of the test connector 22 that are between the light detector and the interface 20 between a stub fiber of the test connector 22 and the field fiber 24 are designed to be highly transmissive while other components surrounding the stub fiber/field fiber interface 20 are designed to include highly reflective surfaces. This will allow the light that is not initially scattered in a direction towards the light detector 18 to be reflected back towards the light detector 18 to be measured.

The light detector 18 will quantify the intensity of light energy scattered into the test connector 22. The light detector may be comprised of a single or multiple photodetectors sensitive to the light energy emitted by the light source 12. Alternatively, the light detector 18 may be comprised of an array of light sensitive elements such as a one-dimensional or two-dimensional CCD or CMOS light sensor. The measured light intensity from the light detector is sent to an analysis circuit 28 which can then compare the intensity of the light against acceptable pass/fail limits. An indicator 30 indicates to a user a pass or fail condition for the test connector.

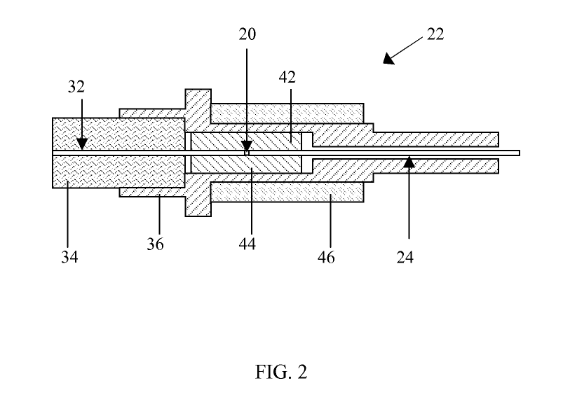

FIG. 2 shows a cross sectional view of a prior art test connector 22. A stub fiber 32 passes through a ferrule 34. The stub fiber 32 is mated to the field fiber 24 at a stub fiber/field fiber interface 20. The stub fiber 32 and field fiber 24 interface 20 is secured between a top plank 42 and a bottom plank 44. The top plank 42 and bottom plank 44 are contained within a ferrule holder 36 and the ferrule 34 is secured to the end of the ferrule holder 36. The planks 42 and 44 are secured within a cam 46. Light that is not coupled from the stub fiber 32 to the field fiber 24 will be scattered through the index matching gel at the stub fiber/field fiber interface 20 towards the components of the test connector 22.

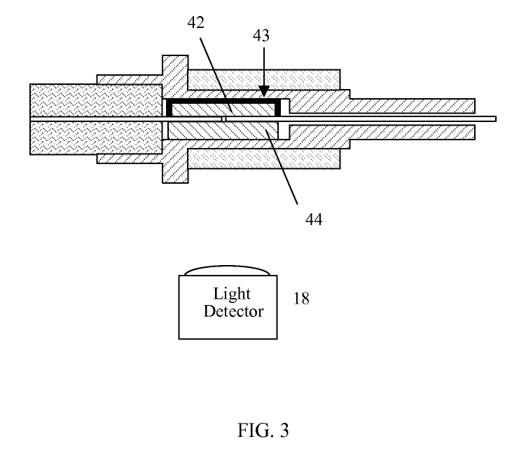

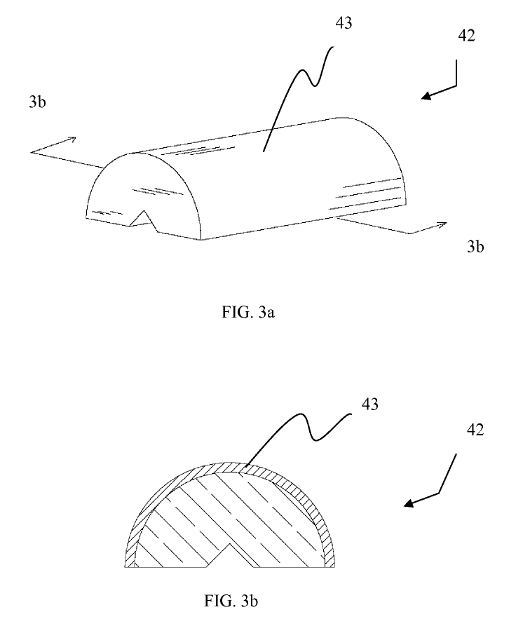

FIG. 3 shows one embodiment of a test connector wherein the bottom plank 44 is transmissive and positioned such that it is between the stub fiber/field fiber interface 20 and the light detector 18. The top plank 42 is transmissive and has a coating 43 of a highly reflective material on a portion of its exterior surface such that any light that is initially scattered into the test connector 22 towards the top plank 42 will be reflected back though the bottom plank 44 and towards the light detector 18. (The thickness of the coating is exaggerated for visibility in FIGS. 3 and 3b.)

FIG. 3a shows a perspective view of the top plank 42 and FIG. 3b shows a cross sectional view of the top plank 42 taken along line 3b-3b of FIG. 3a. The top plank 42 can be made of a transmissive molded plastic with the external surfaces (those not proximate to the optical fiber interface) coated in a reflective material, preferably a reflective metal such as silver, aluminum, or gold. In one embodiment, the thickness of the coating 43 is approximately 100 nm. The coated surfaces of the top plank 42 can be coated using chemical vapor deposition or any other similar method known in the art. Alternatively, the top plank 42 can be made of a reflective metal or semiconductor material.

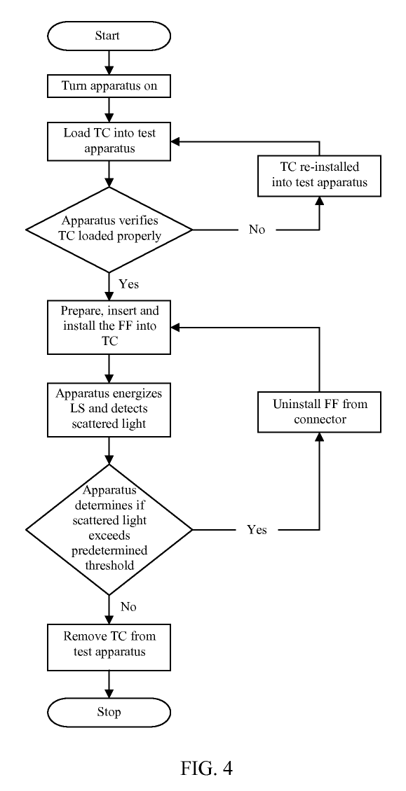

FIG. 4 shows a flow chart detailing a method for testing a fiber optic connection. First the apparatus 10 is turned on. The power supply of the testing apparatus 10 may be used to power the light source 12, the light detector 18, and the analysis circuit 28. Next, the test connector 22 is loaded into the apparatus 10. The lighting conditions proximate to the test connector 22 and light detector 18 can be controlled using by an apparatus 10 with an integrated cover. In one embodiment, the functionality of the light source 12 may be tested through the use of a monitor photodiode mounted near the light source 12. Alternatively, the coupling assembly 14 may tap a known proportion of the light energy emitted by the light source 12 and direct it to a monitor photodiode in order to quantify the power of the light source 12.

Then, in order to determine whether the test connector 22 has been loaded properly, the light source 12 is energized without a field fiber 24 connected to the stub fiber 32. Light will be scattered into the test connector 22 by the unterminated end of the stub fiber 32. The analysis circuit 28 will then determine if the test connector 22 is loaded properly by measuring the value of the light intensity detected by the light detector 18 and comparing it with preprogrammed pass/fail limits. The result of this comparison may be indicated by an auditory or optical signal. If the test connector 22 is not loaded properly, it should be re-installed into the apparatus 10 until the analysis circuit indicates that it is loaded properly.

Once the test connector 22 has been confirmed to be loaded properly, the field fiber 24 is prepared and installed into the test connector 22. The light source 12 should be off during this step. The field fiber 24 is preferably installed into the test connector 22 through the use of a cam mechanism such as the PANDUIT® Opticam® fiber optic connector. The light source 12 is energized and the amount of light scattered into the test connector 22 is measured. In one embodiment, the light source 12 is energized continuously with a constant emission power. Alternatively, the light source 12 may be energized intermittently with emission powers of different magnitudes. The latter embodiment may result in increased levels of spatial contrast that allow for a more accurate appraisal of the mechanical splice quality.

The analysis circuit 28 will then compare the measured intensity of the scattered light with preprogrammed pass/fail limits. In one embodiment, the analysis circuit 28 may use the light measurement from a single light detector 18. Alternatively, the analysis circuit may use measured values of light intensity from multiple light detectors 18. The result of this comparison may be indicated by an optical or auditory signal. If the analysis circuit indicates that the amount of scattered light detected exceeds the pass/fail limits, then the field fiber 24 should be disconnected and reinstalled. Once the analysis circuit has indicated that the amount of scattered light does not exceed the predetermined pass/fail limits, the test connector 22 can be removed from the apparatus 10.

1. A system for verifying the termination quality of a test connector comprising:
an emitter for emitting light;
a coupling assembly for directing light from said emitter to said test connector; and
a light detector for detecting light scattered from said test connector during a test;
wherein said test connector contains at least one transmissive portion for transmitting light toward said detector and at least one reflective portion for reflecting light toward said light detector.

2. The system of claim 1 wherein said coupling assembly comprises a fiber optic cable and a test connector interface for attachment to said test connector.

3. The system of claim 1 wherein said coupling assembly comprises free space optical components.

4. The system of claim 1 wherein said light detector is comprised of an array of light sensitive elements.

5. The system of claim 1 further comprising an analysis circuit that compares the intensity of light detected by said light detector against acceptable pass/fail limits.

6. The system of claim 1 wherein said test connector comprises a first transmissive plank and a second plank having a reflective surface.

7. The system of claim 1 further comprising and indicator for indicating a pass or fail condition for said test connector.

8. The system of claim 1 wherein said light detector is designed to detect frequencies of light emitted by said emitter.

9. The system of claim 6 wherein said reflective surface is a reflective coating on said second plank.

10. The system of claim 6 wherein said second plank is made of a reflective material.
